(19) United States
(12) Patent Application Publication
(10) Pub. No.: US 2013/0010194 A1
(43) Pub. Date: Jan. 10, 2013

(54) TELEVISION-INTEGRATED COMPUTER AND BOOT IMAGE DISPLAYING METHOD THEREOF

(75) Inventors: Ming-Zhao Rui, Xiamen (CN); Tai-Qing Zhang, Xiamen (CN); Wen-Hai Han, Xiamen (CN)

(73) Assignee: TPV DISPLAY TECHNOLOGY (XIAMEN) CO., LTD., Xiamen (CN)

(21) Appl. No.: 13/454,535

(22) Filed: Apr. 24, 2012

(30) Foreign Application Priority Data
Jul. 8, 2011 (TW) 100124241

(51) Int. Cl. H04N 7/00

(52) U.S. Cl. 348/552; 348/E07.001

(57) ABSTRACT

In a method for displaying a boot image on a television-integrated computer that includes a display module, a television (TV) module, and a computer module operable to generate a computer video signal, the TV-integrated computer first determines whether initialization of the TV module has been completed. When initialization has not yet been completed, the computer module allows the display module to display a computer image according to the computer video signal. Otherwise, the computer module outputs the computer video signal to the TV module, and the TV module outputs a display signal according to the computer video signal to the display module to allow the display module to display the computer image according to the display signal.

### CROSS-REFERENCE TO RELATED APPLICATION

This application claims priority to Taiwanese Application No. 100124241, filed on Jul. 8, 2011.

### BACKGROUND OF THE INVENTION

1. Field of the Invention

The invention relates to a computer and a boot image displaying method thereof, and more particularly to a television-integrated computer and a boot image displaying method thereof.

2. Description of the Related Art

Referring to FIG. 1, a conventional television-integrated computer 1 includes a display module 11 (such as a liquid crystal display), a television (TV) module 12 to output a display signal to the display module 11, a computer module 13 to generate a computer video signal that includes data for displaying a computer image, a control module 14 to control operations of the TV module 12 and the computer module 13, and an input module 15 to receive inputs from users so as to transmit operation commands to the control module 14. The computer video signal may be an analog signal (such as a video graphic array (VGA) signal), or a digital signal (such as a digital visual interface (DVI) signal or a high-definition multimedia interface (HDMI) signal). A processing chip (not shown) in the TV module 12 may process the computer video signal by analog-to-digital conversion, decoding, scaling, etc., so as to convert the computer video signal into a display signal in a form of low-voltage differential signal (LVDS) and to output the LVDS to the display module 11 for display. Thus, the display module 11 is operable to simultaneously display the computer image with a TV image and a computer image in a form of a picture-in-picture (PIP) image.

As integration density of the processing chip of the TV module 12 is increased and capability of the processing chip to process digital signals is enhanced, an initialization time of the processing chip when booting the TV module 12 is increased, usually more than 4 seconds and even 13 seconds. However, information of a basic input/output system (BIOS) of the computer module 13 needs to be displayed within 3 seconds after booting so as to allow a user to configure and set components of the TV-integrated computer 1 in time. If the initialization time of the processing chip is too long to display the information of the BIOS on the display module 11 in time, the user may not see the information of the BIOS and thus may not be able to perform related operations accordingly.

### SUMMARY OF THE INVENTION

Therefore, an object of the present invention is to provide a television-integrated computer and a method for displaying a boot image thereof that can display the boot image in time so as to facilitate performing of related operations by a user.

According to the present invention, a method for displaying a boot image on a television-integrated computer that includes a display module, a television (TV) module, and a computer module operable to generate a computer video signal, is to be implemented by the TV-integrated computer and comprises the following steps of:

a) upon receipt of a computer booting command for booting the computer module, configuring the TV-integrated computer to determine whether initialization of the TV module has been completed;

b) when it is determined in step a) that initialization of the TV module has not yet been completed, configuring the computer module to allow the display module to display a computer image according to the computer video signal and configuring the TV-integrated computer to repeat step a); and

c) when the determination made in step a) is affirmative, configuring the computer module to output the computer video signal to the TV module, and configuring the TV module to output to the display module a display signal according to the computer video signal received from the computer module so that the display module is operable to display the computer image according to the display signal.

According to another aspect of the present invention, a TV-integrated computer of the present invention is configured for implementing the above method and comprises a television (TV) module, a computer module coupled to the TV module and operable to generate a computer video signal, and a display module selectively coupled to one of the TV module and the computer module for displaying an image, wherein the computer module is operable to allow the display module to display a computer image according to the computer video signal when initialization of the TV module has not yet been completed, and the TV module is operable to output to the display module a display signal according to the computer video signal received from the computer module when initialization of the TV module has been completed.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram of a conventional television-integrated computer;

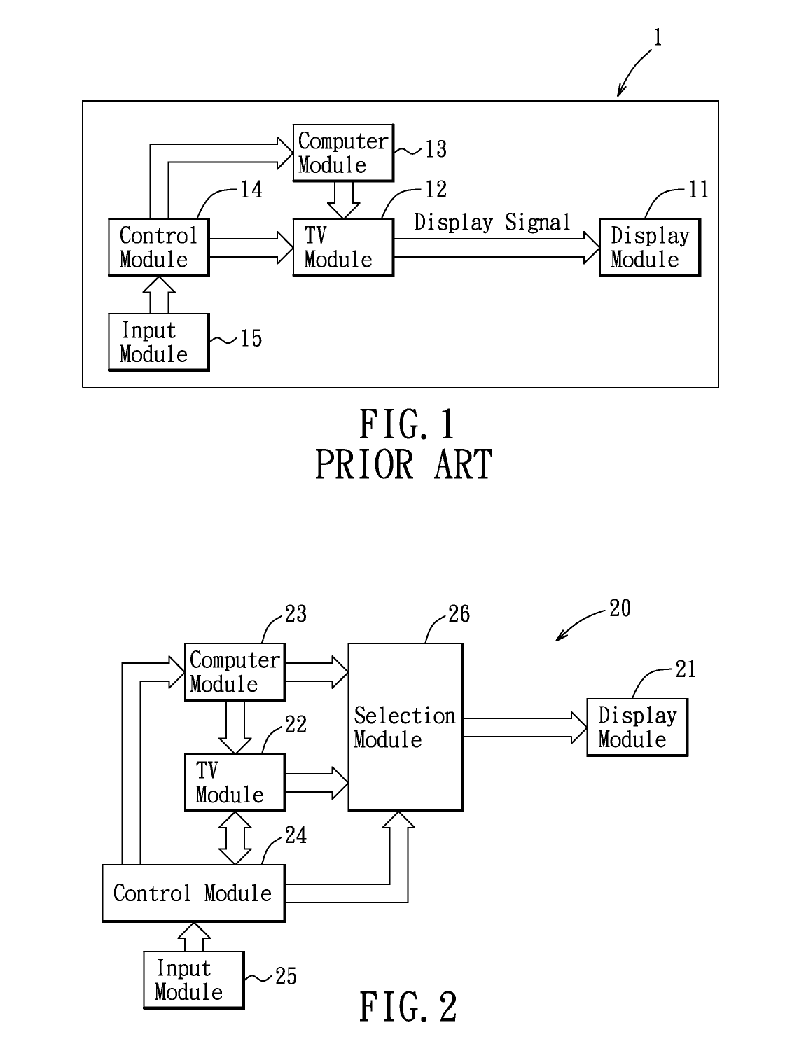

FIG. 2 is a block diagram of a first preferred embodiment of a television-integrated computer according to the present invention;

FIG. 3 is a flow chart of a method for displaying a boot image on the television-integrated computer of the first preferred embodiment according to the present invention;

FIG. 4 is a block diagram illustrating the television-integrated computer of the first preferred embodiment in detail;

FIG. 5 and FIG. 6 illustrate a flow chart of the method for displaying the boot image on the television-integrated computer of the first preferred embodiment; and

FIG. 7 is a block diagram of a second preferred embodiment of the television-integrated computer according to the present invention.

### DETAILED DESCRIPTION OF THE PREFERRED EMBODIMENTS

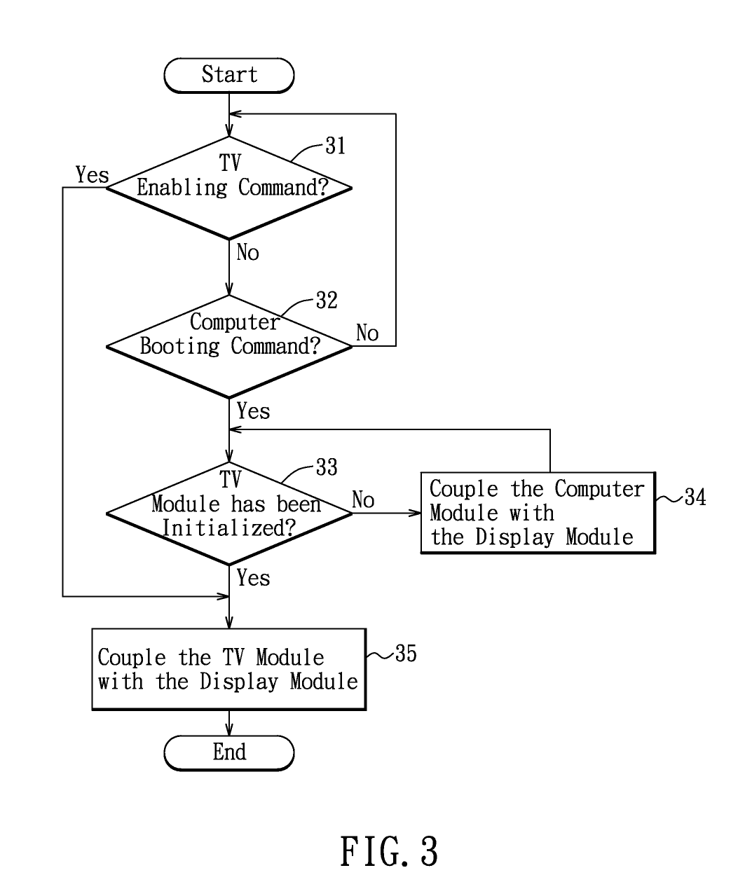

Referring to FIG. 2, the first preferred embodiment of the television-integrated computer 20 according to the present invention includes a display module 21 to display an image, a television (TV) module 22, a computer module 23, a control module 24, an input module 25, a selection module 26, and a power supply (not shown) to provide electric power to the above components. The computer module 23 is coupled to the TV module 22, and is operable to generate a computer video signal that includes data for displaying a computer image. The control module 24 is coupled to the TV module 22 and the computer module 23 so as to control operations thereof. The input module 25 is user operable, and is operable to output an operation command to the control module 24 in response to operation by a user. The selection module 26 is coupled to the display module 21, the TV module 22, the computer module 23 and the control module 24, and is controlled by the control module 24 to couple one of the TV module 22 and the computer module 23 with the display module 21.

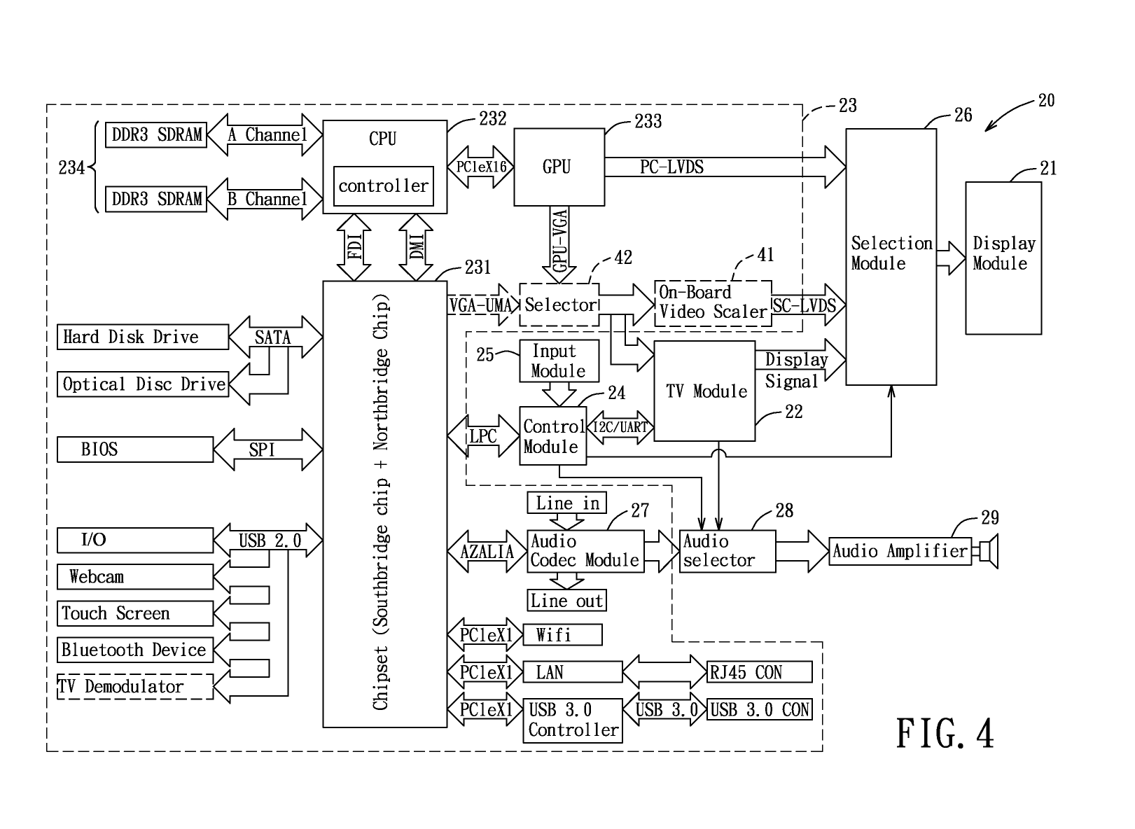

FIG. 3 shows a flow chart of a method for displaying a boot image on the TV-integrated computer 20 of this embodiment. Upon receipt of the operation command from the input module 25, the control module 24 is operable, in step 31, to determine whether the operation command is a TV enabling command for making the TV module 22 process a TV video signal which includes data for displaying a TV image. The flow goes to step 32 when it is determined in step 31 that the operation is not the TV enabling command, and goes to step 35 when otherwise.

In step 32, the control module 24 is operable to determine whether the operation command is a computer booting command for booting the computer module 23. The flow goes back to step 31 when it is determined in step 32 that the operation command is not the computer booting command, and the control module 24 is operable to boot the computer module 23 and to turn on the TV module 22 and then to implement step 33 when otherwise. In step 33, the control module 24 is operable to determine whether initialization of the TV module 22 has been completed. Herein, the initialization of the TV module 22 is to initialize the processing chip of the TV module 22 when turning on the TV module 22. In a case that the TV module 22 turns on after the control module 24 receives the computer booting command, the processing chip of the TV module 22 cannot process the computer video signal from the computer module 23 until the initialization thereof has been completed. However, time for initializing the processing chip of the TV module 22 is generally longer than time for outputting information of a basic input/output system (BIOS) from the computer module 23 to the TV module 22, so that the TV module 22 may not be able to allow the display module 21 to display the information of the BIOS in time. As a result, a user may not see the information of the BIOS and thus may not be able to configure and set components of the TV-integrated computer 20 accordingly.

To avoid the above situation, when the control module 24 determines in step 33 that initialization of the TV module 22 has not yet been completed, the control module 24 is operable, in step 34, to make the computer module 23 output the computer video signal directly to the display module 21, i.e., the control module 24 controls the selection module 26 to couple the computer module 23 with the display module 21. Thus, the computer module 23 is operable to allow the display module 21 to display the computer image (including the information of the BIOS while booting) in time according to the computer video signal. After step 34, the flow goes back to step 33.

When the determination made in step 33 is affirmative, the control module 24 is operable in step 35 to configure the selection module 26 for coupling the TV module 22 and the display module 21, such that the TV module 22 is operable to output a display signal which includes data for displaying the computer image or a TV image, to the display module 21 through the selection module 26 so that the display module 21 is operable to display the computer image or the TV image.

Detailed structure and operation of the TV-integrated computer 20 according to the present invention are described in the following.

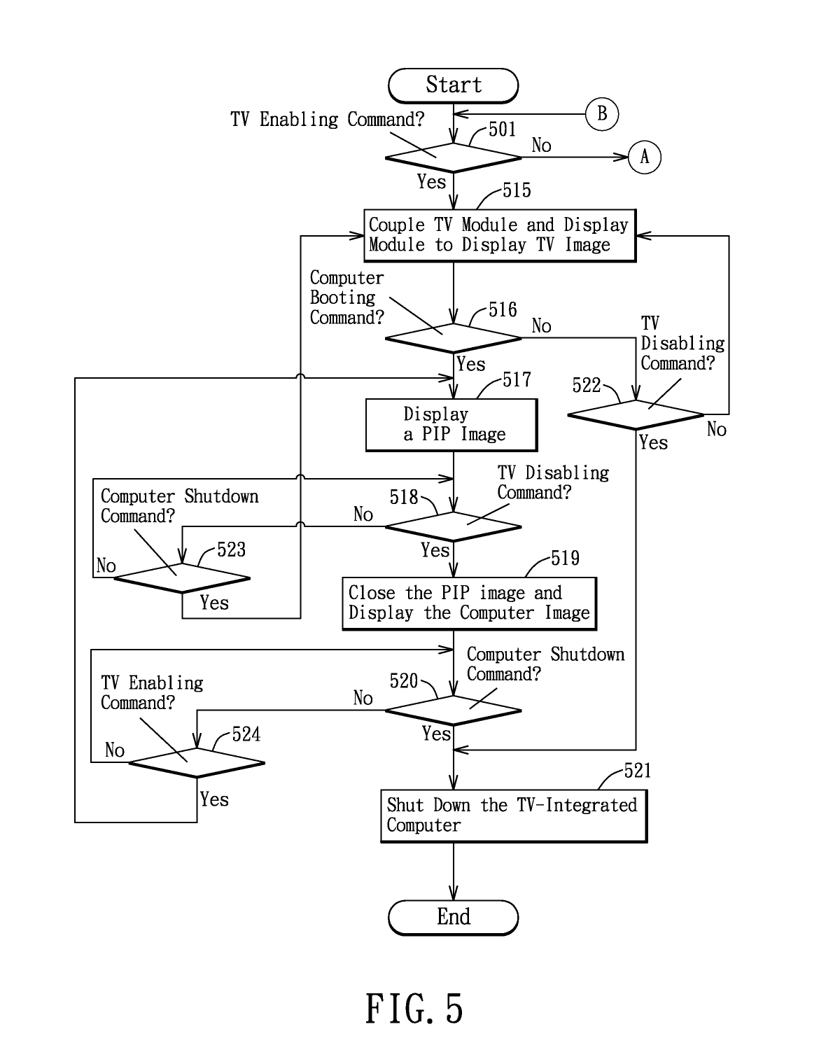

Referring to FIG. 4, the computer module 23 of this embodiment includes a chipset 231 (having a southbridge chip and a northbridge chip), a central processing unit (CPU) 232, a graphic processing unit (GPU) 233, a pair of double data rate type three synchronous dynamic random access memories 234 (DDR3 SDRAMs), etc. The chipset 231 is coupled to a hard disk drive and an optical disc drive through a serial advanced technology attachment (SATA) interface, and is coupled to an input/output device (I/O), a webcam, a touch screen, a bluetooth device, and a TV demodulator through a universal serial bus (USB) 2.0 interface. The chipset 231 is further coupled to an audio codec module 27 through an Azalia standard interface, which is released by Intel, and outputs a computer audio signal to the audio codec module 27 through the AZALIA standard interface. The audio codec module 27 supports audio line in and line out, and outputs a processed computer audio signal to an audio selector 28 of the TV-integrated computer 20. The audio selector 28 further receives a TV audio signal from the TV module 22, and is controlled by the control module 24 to output one of the processed computer audio signal from the computer module 23 and the TV audio signal from the TV module 22 to a back-end audio amplifier 29. Then, the back-end audio amplifier 29 amplifies a received one of the processed computer audio signal and the TV audio signal, and transmits an amplified audio signal to a speaker for sound reproduction.

The chipset 231 is further coupled to a WiFi module, a local area network (LAN) module and a USB 3.0 controller respectively through peripheral component interconnect express (PCIe) buses, is coupled to a flash memory that stores the BIOS through a serial peripheral interface (SPI) bus, is coupled to the control module 24 through a low pin count (LPC) bus, and is coupled to the CPU 232 through a flexible display interface (FDI) bus and a direct media interface (DMI) bus. The GPU 233 is also coupled to the CPU 232 through a PCIe bus. The CPU 232 further includes a controller for the GPU 233 and the DDR3 SDRAMs 234, and supports dual-channel architecture for the DDR3 SDRAMs 234. The GPU 233 is operable to output a digital computer video signal (PC-LVDS) in a form of a low-voltage differential signal (LVDS), or to output an analog computer video signal (GPU-VGA) in a form of video graphic array (VGA) signal. In practice, the GPU 233 may be configured to output a digital computer video signal in a form of a digital visual interface (DVI) signal. In other embodiments, the GPU 233 of the computer module 23 may be omitted, and the chipset 231 is configured to output a digital or analog computer video signal (VGA-UMA, where UMA is abbreviated from uniform memory access). It should be noted that the chipset 231 does not support to output a computer video signal in a form of the LVDS.

In the case of the chipset 231 outputting the analog computer video signal (VGA-UMA), there is an additional requirement of an on-board video scaler 41 to convert the analog computer video signal (VGA-UMA) into a digital computer video signal (SC-LVDS), for example, in a form of the LVDS. In this embodiment, as shown in FIG. 4, the GPU 233 is present in the computer module 23, and thus there is a requirement of a selector 42 disposed among the GPU 233, the chipset 231 and the on-board video scaler 41 for selectively outputting one of the analog computer video signal (GPU-VGA) from the GPU 233 and the analog computer video signal (VGA-UMA) from the chipset 231 to the on-board video scaler 41 and to the TV module 22.

The input module 25 may include, for example, a plurality of press keys disposed on an outer surface of the TV-integrated computer 20, an infrared receiver, a remote controller operable to send an infrared signal, a keyboard, etc. The user can input the operation commands, such as a booting command or a shutdown command, through the press keys, the remote controller or the keyboard. For example, the press keys may include a power key for booting the computer module 23 and a start-up key for turning on the TV module 22.

The control module 24 controls the selection module 26 and the audio selector 28 through a universal asynchronous receiver/transmitter (UART) or an inter-integrated circuit (I²C) bus according to the operation commands from the input module 25.

In this embodiment, the selection module 26 is a selection switch receiving the digital computer video signal (PC-LVDS and SC-LVDS) from the computer module 23, and the display signal from the TV module 22 that may include the digital computer video signal, the TV video signal, and a combination thereof. The control module 24 is operable to control the selection module 26 to couple one of the TV module 22 and the computer module 23 with the display module 21 according to a current state of the TV module 22 and the operation commands from the input module 25.

The display module 21 is a liquid crystal display operable to display the image according to a signal received from the selection module 26 in this embodiment.

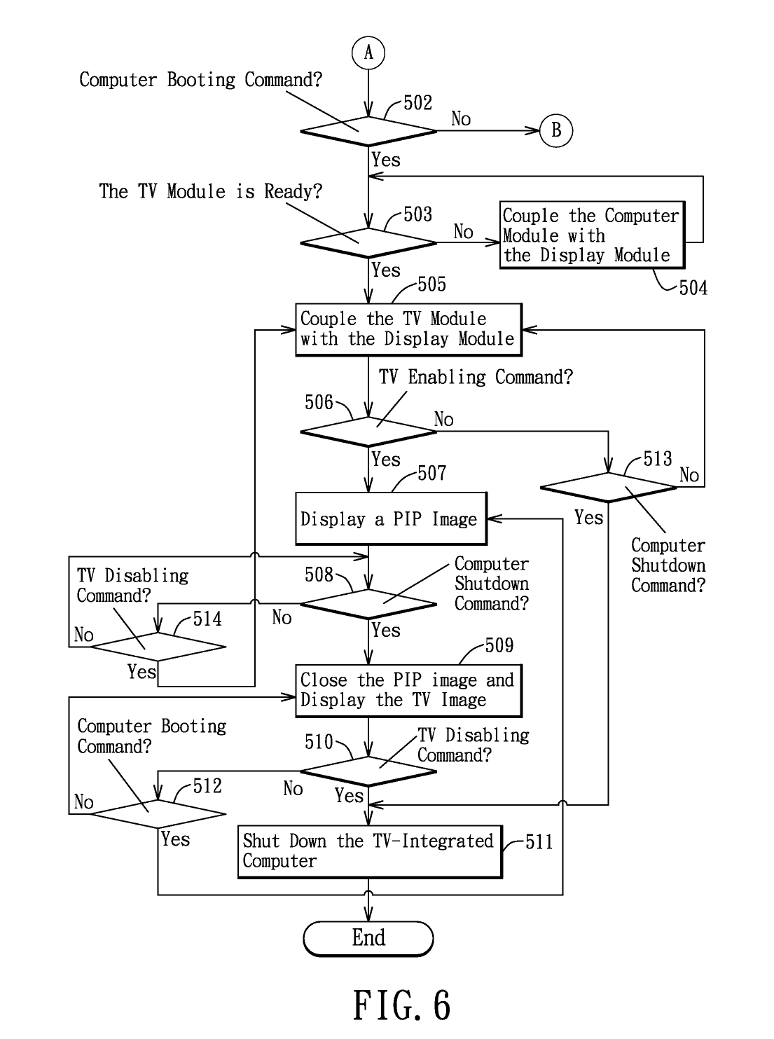

Referring to FIG. 5 and FIG. 6, when the control module 24 receives the operation command from the input module 25, the control module 24 is operable, in step 501, to determine whether the operation command is the TV enabling command. The flow goes to step 515 when the determination made in step 501 is affirmative, and goes to step 502 when otherwise.

In step 502, the control module 24 is operable to determine whether the operation command is the computer booting command. When it is determined in step 502 that the operation command is not the computer booting command, the flow goes back to step 501. When the determination made in step 502 is affirmative, the control module 24 is operable to boot the computer module 23 and to turn on the TV module 22, and is operable to implement step 503 to determine whether the TV module 22 is ready, that is to say, initialization of the processing chip of the TV module 22 has been completed. In this embodiment, the TV module 22 has a pin, and the control module 24 is operable to detect a level of the pin of the TV module 22 and to determine whether initialization of the TV module 22 has been completed according to the level of the pin. Alternatively, the control module 24 may be configured to determine whether a predefined initialization time for initializing the TV module 22 has elapsed, and to determine that initialization of the TV module 22 has been completed when the predefined initialization time has elapsed.

When it is determined in step 503 that the TV module 22 is not yet ready, the control module 24 is operable to implement step 504 to control the selection module 26 to couple the computer module 23 with the display module 21 so as to allow the display module 21 to display the computer image according to the computer video signal (PC-LVDS or SC-LVDS) generated by the computer module 23, and the flow goes back to step 503. When the determination made in step 503 is affirmative, the control module 24 is operable, in step 505, to control the selection module 26 to couple the TV module 22 with the display module 21. In particular, the processing chip of the TV module 22 is operable to process the computer video signal (for example, by analog-to-digital conversion, decoding, scaling, etc.) so as to generate the display signal in a form of the LVDS, and to output the display signal to the display module 21 for displaying the computer image according to the display signal.

In step 506, the control module 24 is operable to determine whether a TV enabling command is received from the input module 25. The flow goes to step 507 when the determination made in step 506 is affirmative, and goes to step 513 when otherwise.

In step 513, the control module 24 is operable to determine whether a computer shutdown command for shutting down the computer module 23 is received from the input module 25. The flow goes back to step 505 when the control module 24 fails to receive the computer shutdown command, and goes to step 511 to shut down the computer module 23 and to turn off the TV module 22 when otherwise.

In step 507, the TV module 22 is operable to process the computer video signal with the TV video signal, which includes the data for displaying the TV image, so as to obtain the display signal allowing the display module 21 to display a composite image including the computer image and the TV image associated with the computer video signal and the TV video signal, respectively. In this embodiment, the composite image is in a form of a picture-in-picture (PIP) image, and the composite image includes a primary image that is the TV image and a sub-image that is the computer image, such that users are able to control functions of the computer module 23 and TV module 22 without switching images. Further, the primary image and the sub-image may be switchable, that is to say, the primary image may be changed from the TV image to the computer image.

Then, instep 508, the control module 24 is operable to determine whether the computer shutdown command is received. When it is determined in step 508 that the computer shutdown command is not received, the control module 24 is operable, in step 514, to determine whether a TV disabling command for disabling display of the TV image is received. The flow goes back to step 505 when the determination made in step 514 is affirmative, and goes back to step 508 when otherwise. When the determination made in step 508 is affirmative, the control module 24 is operable, in step 509, to shut down the computer module 23 and to control the TV module 22 to close the composite image (i.e., the PIP image), such that the TV module 22 outputs the display signal including the TV video signal only. As a result, the display module 21 is operable to display a single image, i.e., the TV image.

Then, instep 510, the control module 24 is operable to determine whether the TV disabling command is received. Afterward, the control module 24 is operable, in step 511, to turnoff the TV module 22 when the determination made in step 510 is affirmative. Otherwise, in step 512, the control module 24 determines whether the computer booting command is received. The flow goes back to step 507 when the determination made in step 512 is affirmative, and goes back to step 509 when otherwise. On the other hand, in step 515, the control module 24 is operable to control the selection module 26 to couple the TV module 22 with the display module 21 when it is determined in step 501 that the TV enabling command is received. Accordingly, the display module 21 is operable to display the TV image according to the display signal that is based only on the TV video signal. Then, in step 516, the control module 24 is operable to determine whether the computer booting command is received. The control module 24 is operable to boot the computer module 23 and the flow goes to step 517 when the determination made in step 516 is affirmative, and the flow goes to step 522 when otherwise.

In step 522, the control module 24 is operable to further determine whether the TV disabling command is received. Then, the control module 24 is operable, in step 521, to turn off the TV module 22 when the determination made in 522 is affirmative, and the flow goes back to step 516 when otherwise.

In step 517, the control module 24 is operable to control the TV module 22 to display the composite image in the form of the PIP image in this embodiment. Then, in step 518, the control module 24 is operable to determine whether the TV disabling command is received. When it is determined in step 518 that the TV disabling command is not received, the control module 24 is operable, in step 523, to determine whether the computer shutdown command is received. The flow goes back to step 515 when the determination made in step 523 is affirmative, and goes back to step 518 when otherwise.

When the determination made in step 518 is affirmative, the TV module 22 is operable, in step 519, to close the PIP image, and to output to the display module 21 the display signal based only on the computer video signal. Then, in step 520, the control module 24 is operable to determine whether the computer shutdown command is received. Afterward, the control module 24 is operable, in step 521, to shut down the computer module 23 and to turn off the TV module 22 when the determination made in step 520 is affirmative. Otherwise, in step 524, the control module 24 determines whether the TV enabling command is received. The flow goes back to step 517 when the determination made in step 524 is affirmative, and goes back to step 520 when otherwise.

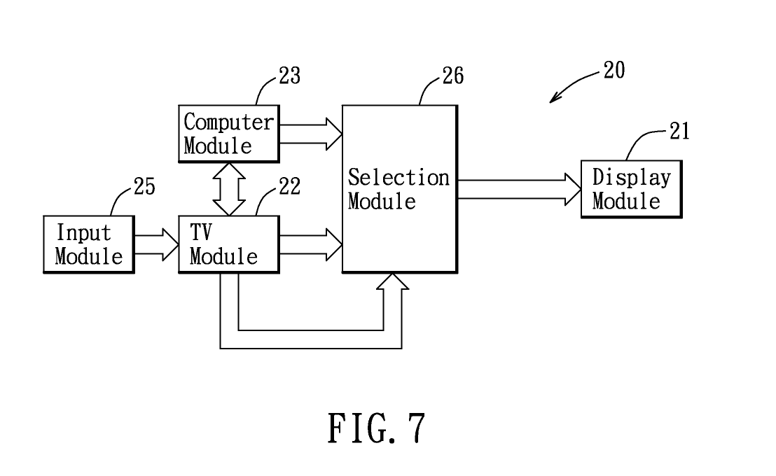

Referring to FIG. 7, a second preferred embodiment of the TV-integrated computer 20 according to the present invention is shown to be similar to the first preferred embodiment. In this embodiment, the control module 24 is omitted, and the input module 25 is coupled to the TV module 23 so as to output the operation commands to the TV module 23. Referring to FIG. 3, the TV module 23 is operable to determine whether the TV enabling command and the computer booting command are received in step 31 and step 32, respectively, and to determine whether initialization of the processing chip thereof has been completed in step 33. Further, the TV module 23 of this embodiment is operable to control the selection module 26 to couple the display module 21 with the TV module 22 and the computer module 23 in step 34 and step 35, respectively. In this embodiment, the TV module 22 is operable to determine whether the predefined initialization time for initializing the processing chip thereof has elapsed, and to determine that the initialization has been completed when the predefined initialization time has elapsed.

To sum up, when the TV-integrated computer 20 according to the present invention receives the computer booting command, it determines whether initialization of the TV module 22 has been completed. When it is determined that initialization of the TV module 22 has not yet been completed, the computer module 23 is configured to be coupled to the display module 21, thereby allowing the display module 21 to display the computer image according to the computer video signal, so as to facilitate performing of related operations by a user. When it is determined that initialization of the TV module 22 has been completed, the TV module 22 is configured to be coupled to the display module 21 to output to the display module 21 the display signal according to the computer video signal, the TV video signal, or a combination thereof, so that the display module 21 is operable to display images according to the display signal.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for displaying a boot image on a television-integrated computer that includes a display module, a television (TV) module, and a computer module operable to generate a computer video signal, said method to be implemented by the TV-integrated computer and comprising the following steps of:
a) upon receipt of a computer booting command for booting the computer module, configuring the TV-integrated computer to determine whether initialization of the TV module has been completed;
b) when it is determined in step a) that initialization of the TV module has not yet been completed, configuring the computer module to allow the display module to display a computer image according to the computer video signal and configuring the TV-integrated computer to repeat step a); and
c) when the determination made in step a) is affirmative, configuring the computer module to output the computer video signal to the TV module, and configuring the TV module to output to the display module a display signal according to the computer video signal received from the computer module so that the display module is operable to display the computer image according to the display signal.

2. The method as claimed in claim 1, the TV module having a pin, wherein, in step a), the TV-integrated computer is configured to detect a level of the pin of the TV module, and to determine whether initialization of the TV module has been completed according to the level of the pin.

3. The method as claimed in claim 1, wherein, in step a), the TV-integrated computer is configured to determine whether a predefined initialization time for initializing the TV module has elapsed, and to determine that initialization of the TV module has been completed when the predefined initialization time has elapsed.

4. The method as claimed in claim 1, wherein, in step a), whether initialization of the TV module of the TV-integrated computer has been completed is determined by the TV module.

5. The method as claimed in claim 1, further comprising, after step c), the step of configuring the TV module to process the computer video signal with a TV video signal, which includes data for displaying a TV image, so as to obtain the display signal allowing the display module to display a composite image including the computer image and the TV image associated with the computer video signal and the TV video signal, respectively.

6. A television-integrated computer comprising:
a television (TV) module;
a computer module coupled to said TV module and operable to generate a computer video signal; and
a display module selectively coupled to one of said TV module and said computer module for displaying an image;
wherein said computer module is operable to allow said display module to display a computer image according to the computer video signal when initialization of said TV module has not yet been completed, and said TV module is operable to output to said display module a display signal according to the computer video signal received from said computer module when initialization of said TV module has been completed.

7. The TV-integrated computer as claimed in claim 6, further comprising a control module operable to control operations of said TV module and said computer module, to determine whether initialization of said TV module has been completed, to make said computer module output the computer video signal to said display module upon determining that initialization of said TV module has not yet been completed, and to make said TV module output the display signal according to the computer video signal received from said computer module to said display module upon determining that initialization of said TV module has been completed.

8. The TV-integrated computer as claimed in claim 7, further comprising a selection module coupled to said TV module, said computer module, said display module and said control module, and controlled by said control module to couple one of said TV module and said computer module with said display module.

9. The TV-integrated computer as claimed in claim 7, further comprising a user-operable input module coupled to said control module, and operable to output a computer booting command for booting said computer module to said control module in response to operation by a user,
wherein said control module is operable, upon receipt of the computer booting command, to determine whether initialization of said TV module has been completed.

10. The TV-integrated computer as claimed in claim 7, wherein said TV module has a pin, and said control module is operable to detect a level of said pin of said TV module and to determine whether initialization of said TV module has been completed according to the level of said pin.

11. The TV-integrated computer as claimed in claim 7, wherein said control module stores a predefined initialization time for initializing said TV module, and is operable to determine whether the predefined initialization time has elapsed and to determine that initialization of said TV module has been completed when the predefined initialization time has elapsed.

12. The TV-integrated computer as claimed in claim 6, wherein whether initialization of said TV module has been completed is determined by said TV module.

13. The TV-integrated computer as claimed in claim 12, further comprising a selection module coupled to said TV module, said computer module and said display module, and controlled by said TV module to couple one of said TV module and said computer module with said display module.

14. The TV-integrated computer as claimed in claim 12, wherein said TV module stores a predefined initialization time, and is operable to determine whether the predefined initialization time has elapsed and to determine that initialization of said TV module has been completed when the predefined initialization time has elapsed.

15. The TV-integrated computer as claimed in claim 6, wherein said TV module is operable to process the computer video signal with a TV video signal, which includes data for displaying a TV image, so as to obtain the display signal allowing said display module to display a composite image including the computer image and the TV image associated with the computer video signal and the TV video signal, respectively.
